(19) United States
(12) Patent Application Publication
(10) Pub. No.: US 2025/0260969 A1
(43) Pub. Date: Aug. 14, 2025

(54) METHOD AND DEVICE FOR SIMULTANEOUSLY FACILITATING TELEPHONE CALLS

(71) Applicant: SAMSUNG ELECTRONICS CO., LTD., Suwon-si (KR)

(72) Inventor: Gurmanjeet Singh SIDHU, Noida (IN)

(73) Assignee: SAMSUNG ELECTRONICS CO., LTD., Suwon-si (KR)

(21) Appl. No.: 19/184,699

(22) Filed: Apr. 21, 2025

Related U.S. Application Data
(63) Continuation of application No. PCT/KR2023/010979, filed on Jul. 27, 2023.

(30) Foreign Application Priority Data
Oct. 21, 2022 (IN) 202211060394

(51) Int. Cl. H04W 8/18; H04W 4/16; H04W 12/06

(52) U.S. Cl. CPC H04W 8/183; H04W 4/16; H04W 12/06

(57) ABSTRACT

A method performed by an electronic device for facilitating a plurality of telephone calls, may include: detecting an initiation of a first telephone call associated with a first Subscriber Identity Module (SIM) of the electronic device, wherein the initiation of the first telephone call is via one of a first SIM network or a second SIM network; detecting an initiation of a second telephone call associated with a second SIM of the electronic device, wherein the initiation of the second telephone call is via one of the first SIM network or the second SIM network; and activating a Natural Language Engine (NLE) for processing one of the first telephone call or the second telephone call as an NLE call, while another of the first telephone call or the second telephone call is active via a voice interaction as a voice call.

### CROSS-REFERENCE TO RELATED APPLICATIONS

This application is a continuation application of International Application No. PCT/KR2023/010979, filed on Jul. 27, 2023, in the Korean Intellectual Property Receiving Office, which claims priority to Indian Patent Application No. 202211060394, filed on Oct. 21, 2022, in the Indian Patent Office, the disclosures of which are incorporated by reference herein in their entireties.

### BACKGROUND

### 1. Field

The present disclosure generally relates to facilitating a plurality of telephone calls, and more particularly, to a method and an electronic device for facilitating a plurality of telephone calls in an electronic device.

### 2. Description of Related Art

In the related art, when a User Equipment (UE) is in a standby mode, there is no active uplink or downlink communication. The UE is just listening to a paging channel. The UE may move from the standby mode to an active mode as a response to paging or if there is some uplink information to send.

In a single radio multi-SIM device such as Dual SIM Dual Standby (DSDS) device, if User is in Call over SIM 1, radio becomes unavailable for SIM 2 (SIM 2 standby mode), therefore SIM 2 calls are not received in mobile, hence receiving (MT) and with SIM 2 call interaction (listen/text), while SIM 1 call is impossible. Further, if User is in Call over SIM 1, radio becomes unavailable for SIM 2 (SIM 2 standby mode), therefore any outgoing communication (MO) for SIM 2 is not possible, hence SIM 2 call interaction while SIM 1 call is impossible.

Further, the problem arises due to reasons that DSDS smartphone comes with single radio which can handle all communication for only one SIM at a time, and mobile can handle one call at a time since a user can listen/speak with one user only.

A related art solution discloses a method to enable the simultaneous call on both the SIMs in the dual SIM dual-dual RF scenario in a Dual SIM Dual Active (DSDA) device. A call on SIM 1 comes over the first RF and call on SIM2 comes over the second RF, then using the text engine, one of the calls is routed to the engine and answered using text. Related art is defined for the DSDA chipset (device with the dual RF to latch both the SIMS simultaneously) to provide the simultaneous access to both the calls and the related art solution cannot be implemented over a single RF.

Another related art solution discloses a method to access the services of the secondary sim card using the network of the primary sim card. Secondary SIM card (SIM2) register to Secondary server using the network of the primary SIM card (SIM 1) to allow the access of the SIM 2 services. User can receive calls/Texts for the Secondary sim card when the secondary sim is in no service using the primary SIM card data connection. The other related art solution allows user to interact with the services over the Secondary SIM when it is in no service, while there is no provision for interaction with the both the calls received with the primary and secondary SIM where the secondary SIM is registered over the primary network

There is a need for a solution to overcome the above-mentioned drawbacks.

### SUMMARY

This summary is provided to introduce a selection of concepts in a simplified format that are further described in the detailed description of the present disclosure. This summary is not intended to identify key or essential inventive concepts of the claimed subject matter, nor is it intended for determining the scope of the claimed subject matter. In accordance with the purposes of the disclosure.

Provided are a method and an electronic device for simultaneously facilitating telephone calls in an electronic device.

According to an aspect of the disclosure, a method performed by an electronic device for facilitating a plurality of telephone calls, may include: detecting an initiation of a first telephone call associated with a first Subscriber Identity Module (SIM) of the electronic device, wherein the initiation of the first telephone call is via one of a first SIM network or a second SIM network; detecting an initiation of a second telephone call associated with a second SIM in the electronic device, wherein the initiation of the second telephone call is via one of the first SIM network or the second SIM network; and activating a Natural Language Engine (NLE) for processing one of the first telephone call or the second telephone call as an NLE call, while another of the first telephone call or the second telephone call is active via a voice interaction as a voice call.

According to an aspect of the disclosure, an electronic device for facilitating a plurality of telephone calls, may include: at least one processor; and at least one memory storing instructions, wherein the instructions, when executed by the at least one processor individually or collectively, cause the device to: detect an initiation of a first telephone call associated with a first Subscriber Identity Module (SIM) of the electronic device, wherein the initiation of the first telephone call is via one of a first SIM network or a second SIM network; detect an initiation of a second telephone call associated with a second SIM of the electronic device, wherein the initiation of the second telephone call is via one of the first SIM network or the second SIM network; and activate a Natural Language Engine (NLE) for processing one of the first telephone call or the second telephone call as an NLE call, while another of the first telephone call and the second telephone call is active via a voice interaction as a voice call.

According to an aspect of the disclosure, a non-transitory computer-readable medium stores instructions to be executed by at least one processor of an electronic device to cause the electronic device perform a method for facilitating a plurality of telephone calls, the method including: detecting an initiation of a first telephone call associated with a first Subscriber Identity Module (SIM) in an electronic device, wherein the initiation of the first telephone call is via one of a first SIM network or a second SIM network; detecting an initiation of a second telephone call associated with a second SIM in the electronic device, wherein the initiation of the second telephone call is via one of the first SIM network or the second SIM network; and activating a Natural Language Engine (NLE) for processing one of the first telephone call or the second telephone call as an NLE call, while another of the first telephone call or the second telephone call is active via a voice interaction as a voice call.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a flow diagram depicting a method implemented in an electronic device for facilitating a plurality of telephone calls, in accordance with an embodiment of the disclosure;

FIG. 2A illustrates a schematic block diagram of an electronic device for facilitating a plurality of telephone calls, in accordance with an embodiment of the disclosure;

FIG. 2B illustrates a schematic block diagram of an electronic device for facilitating a plurality of telephone calls, in accordance with an embodiment of the disclosure;

FIG. 3 illustrates a flow diagram depicting a process for facilitating a plurality of telephone calls, in accordance with an embodiment of the disclosure;

FIG. 4 illustrates an architectural flow diagram of an electronic device configured to facilitate a plurality of telephone calls, in accordance with an embodiment of the disclosure; and

FIG. 5A illustrates an operational flow diagram depicting a process for preparing a number of resources required for a first telephone call, in accordance with an embodiment of the disclosure; and

FIG. 5B illustrates an operational flow diagram depicting a process for preparing a number of resources for a second telephone call while the first telephone call is active, in accordance with an embodiment of the disclosure;

FIG. 6 illustrates an operational flow diagram depicting a process for processing one telephone call among a first telephone call and a second telephone call in a predefined conversion mode, in accordance with an embodiment of the disclosure; and

FIG. 7 illustrates a diagram depicting an audio box for continuing one of a first telephone call and a second telephone call, in accordance with an embodiment of the disclosure.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the described embodiments, and such further applications of the principles of the disclosure being contemplated as would normally occur to one skilled in the art to which the disclosure relates.

It will be understood by those skilled in the art that the foregoing general description and the following detailed description are explanatory of the disclosure and are not intended to be restrictive thereof.

Further, skilled artisans will appreciate that elements in the drawings are illustrated for simplicity and may not have been necessarily drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this disclosure belongs. The devices, methods, and examples provided herein are illustrative only and not intended to be limiting.

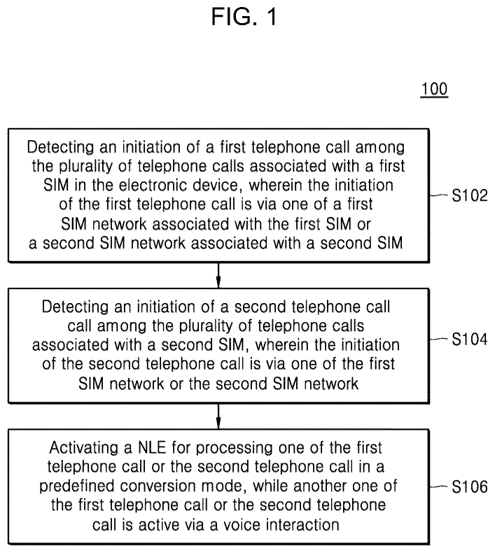

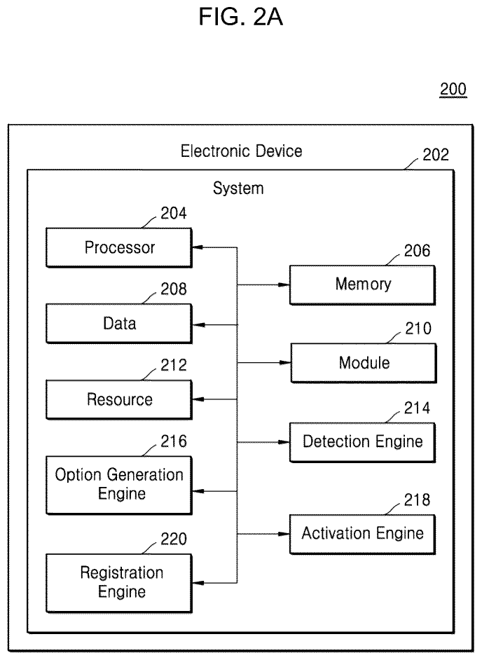

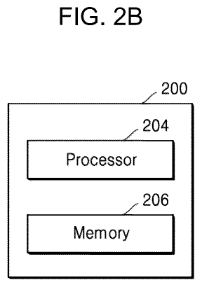

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2, and so on and so forth.

Embodiments of the present subject matter are described below in detail with reference to the accompanying drawings.

FIG. 1 illustrates a flow diagram depicting a method 100 for facilitating a plurality of telephone calls, in accordance with an embodiment of the disclosure. The method 100 may be implemented in an electronic device. Examples of the electronic device may include, but are not limited to, a mobile device, a smartphone, a laptop, a Personal Computer (PC), and a tablet. The method 100 may be configured to employ a Natural Language Engine (NLE) for facilitation of the plurality of telephone calls. According to an embodiment of the disclosure, the electronic device may be a single radio multi-SIM device.

At block S102, the method 100 includes detecting that an initiation of a first telephone call among the plurality of telephone calls associated with a first Subscriber Identity Module (SIM) in the electronic device, wherein the initiation of the first telephone call is via one of a first SIM network associated with the first SIM or a second SIM network associated with a second SIM.

According to an embodiment of the disclosure, the first telephone call may occur based on at least one of the first SIM network connected with the first SIM, the first SIM network connected with the second SIM, the second SIM network connected with the second SIM, or the second SIM network connected with the first SIM.

At block S104, the method 100 includes detecting an initiation of a second telephone call among the plurality of telephone calls associated with a second SIM, wherein the initiation of the second telephone call is via one of the first SIM network and the second SIM network.

According to an embodiment of the disclosure, the second telephone call may occur based on at least one of the first SIM network associated with the first SIM, the first SIM network associated with the second SIM, the second SIM network associated with the second SIM, or the second SIM network associated with the first SIM. According to an embodiment of the disclosure, the electronic device may detect that one SIM among the first SIM and the second SIM is moved to a standby mode in response to initiation of the first telephone call via the other SIM among the first SIM and the second SIM. A network service associated with the on SIM may be unavailable. The electronic device may determine whether the other network service associated with the other SIM is available and register the one SIM in the standby mode on the other network service associated with the other SIM in response to the determination for activating the one SIM on an evolved packet Data Gateway (ePDG) of the other SIM.

At block S106, the method 100 includes activating a Natural Language Engine (NLE) for processing one of the first telephone call or the second telephone call in a predefined conversion mode (an NLE call), while another one of the first telephone call or the second telephone call is active via a voice interaction (a voice call).

According to an embodiment of the disclosure, the electronic device may provide option to a user for selecting one of the first telephone call or the second telephone call for the voice interaction. And the electronic device may receive an input signal indication which of the first telephone call and the second telephone call is selected for activation via the voice interaction, from the user. After receiving the input signal, the electronic device may connect a call buffer associated with a call other than one of the fist telephone call and the second telephone call selected for the voice interaction with the NLE. The electronic device may connect a microphone buffer and a speaker buffer to one or more call buffers associated with the one of the first telephone call or the second telephone call selected for activation via the voice interaction.

According to an embodiment of the disclosure, the conversion mode may include receiving a first text from a user of the electronic device and converting the first text into a speech. And the conversion mode may include receiving an incoming audio from another user of one of the first telephone call or the second telephone call being processed by NLE, and converting the incoming audio onto a second text.

FIG. 2A illustrates a schematic block diagram of an electronic device 200 including a system 202 configured to facilitate a plurality of telephone calls, in accordance with one or more embodiments of the disclosure. The embodiment of the system 202 shown in FIG. 2A is for illustration only. Other embodiments of the system 202 could be used without departing from the scope of this disclosure. In an embodiment, the system 202 may be incorporated in an electronic device. The electronic device may be a single radio multi-SIM device. Examples of the electronic device may include, but are not limited to, a smartphone, a laptop, a PC, and a tablet. The system 202 may be configured to facilitate the number of telephone calls simultaneously such that a user is capable to initiate or receive two telephone calls at a time. The number of telephone calls may include a first telephone call and a second telephone call. The first telephone call and the second telephone call may be one of an audio call between two users, and an audio conference call between at least three users.

In one example embodiment, the system 202 can be a chip incorporated in the electronic device. In another example embodiment, the system 202 may be an implemented software, a logic-based program, a hardware, a configurable hardware, and the like. The system 202 includes a processor 204, a memory 206, data 208, module(s) 210, resources(s) 212, a detection engine 214, an option generation engine 216, an activation engine 218, and a registration engine 220. In an embodiment of the disclosure, the system 202 may exclude at least one of these components or may add at least one other component.

The processor 204, the memory 206, the data 208, the module(s) 210, the resources(s) 212, the detection engine 214, the option generation engine 216, the activation engine 218, and the registration engine 220 may be communicatively coupled to one another.

At least one of the plurality of modules may be implemented through an AI model. A function associated with AI may be performed through the non-volatile memory, the volatile memory, and the processor.

The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

According to the disclosure, in a method of an electronic device, a method for generating a plurality of instructions for enhancing motor skills of a user may use an artificial intelligence model to recommend/execute the plurality of instructions by using sensor data. The processor may perform a pre-processing operation on the data to convert into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the present subject matter, in a method of an electronic device, a method for facilitating a number of telephone calls may receive a speech signal, which is an analog signal, via (e.g., a microphone) and convert the speech part into computer readable text using an automatic speech recognition (ASR) model. The user's intent of utterance may be obtained by interpreting the converted text using a natural language understanding (NLU) model. The ASR model or NLU model may be an artificial intelligence model. The artificial intelligence model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Language understanding is a technique for recognizing and applying/processing human language/text and includes, e.g., natural language processing, machine translation, dialog system, question answering, or speech recognition/synthesis.

*48In an example, the processor 204 may be a single processing unit or a number of units, all of which could include multiple computing units. The processor 204 may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 204 may be configured to fetch and/or execute computer-readable instructions and/or data stored in the memory 206.

In an example, the memory 206 may include any non-transitory computer-readable medium known in the art including, for example, volatile memory, such as static random-access memory (SRAM) and/or dynamic random-access memory (DRAM), and/or non-volatile memory, such as read-only memory (ROM), erasable programmable ROM (EPROM), flash memory, hard disks, optical disks, and/or magnetic tapes. The memory 206 may include the data 208.

The data 208 serves, among other things, as a repository for storing data processed, received, and generated by one or more of the processor 204, the module(s) 210, the resources(s) 212, the detection engine 214, the option generation engine 216, the activation engine 218, and the registration engine 220.

The module(s) 210, among other things, may include routines, programs, objects, components, data structures, etc., which perform particular tasks or implement data types. The module(s) 210 may also be implemented as, signal processor(s), state machine(s), logic circuitries, and/or any other device or component that manipulate signals based on operational instructions.

Further, the module(s) 210 may be implemented in hardware, instructions executed by at least one processing unit, for e.g., processor 204, or by a combination thereof. The processing unit may be a general-purpose processor which executes instructions to cause the general-purpose processor to perform operations or, the processing unit may be dedicated to performing the required functions. In another aspect of the present disclosure, the module(s) 210 may be machine-readable instructions (software) which, when executed by a processor/processing unit, may perform any of the described functionalities.

In some example embodiments, the module(s) 210 may be machine-readable instructions (software) which, when executed by a processor/processing unit, perform any of the described functionalities.

The resource(s) 212 may be physical and/or virtual components of the system 202 that provide inherent capabilities and/or contribute towards the performance of the system 202. Examples of the resource(s) 212 may include, but are not limited to, a memory (e.g., the memory 206), a power unit (example, a battery), a display unit, etc. The resource(s) 212 may include a power unit/battery unit, a network unit, etc., in addition to the processor 204, and the memory 206.

Continuing with the above embodiment, the detection engine 214 may be configured to detect that the first telephone is initiated in the electronic device. The first telephone call may be for a first SIM. Furthermore, the first telephone call may be initiated via one of a first SIM network related to the first SIM, and a second SIM network related to a second SIM. Initiating the first telephone call may indicate that the first telephone call is active, and the first telephone call may be initiated from the electronic device or received at the electronic device.

Moving forward with the above embodiment, the detection engine 214 may be configured to detect one of a dialing and a reception of the second telephone call in the electronic device. The second call may be for the second SIM. Further, the second telephone call may be dialed from the electronic device or received at the electronic device via one of the first SIM network and the second SIM network. The second telephone call may be dialed or received at a time when the first telephone is active such that the fist telephone call and the second telephone call are simultaneously active. Furthermore, the Second telephone call may be initiated via one of the second SIM network related to the second SIM, and the second SIM network related to the second SIM.

Moving forward, the detection engine 214 may be configured to detect that one SIM among the first SIM and the second SIM is moved to a standby mode. The one SIM may be associated with a network service and the network service for the one SIM may be unavailable. The detection may be performed in response to initiation of the first telephone call via another SIM among the first SIM and the second SIM.

Continuing with the above embodiment, the detection engine 214 may be configured to determine whether another network service associated with the other SIM is available. Furthermore, the registration engine 220 may be configured to register the one SIM in the standby mode on the other network service associated with the other SIM for activating the one SIM on an evolved Packet Data Gateway (ePDG) of the other SIM. The one SIM may be registered in response to the determination that the other network service associated with the other SIM is available.

In response to detection of the first telephone call and the second telephone call being active simultaneously by the detection engine 214, the option generation engine 216 may be configured to provide an option to the user. The option may be for selecting one of the first telephone call and the second telephone call for the voice interaction. In response to providing the option, the option generation engine 216 may be configured to receive a command from the user indicating that one of the first telephone call and the second telephone call is selected for the voice interaction. In an embodiment, the user may select the first telephone call for the voice interaction.

In another embodiment, the user may select the second telephone call for the voice interaction. The voice interaction may indicate that one of the first telephone call and the second telephone call selected for the voice interaction is to be continued as an audio call. Furthermore, the option generation engine 216 may be configured to connect a call buffer related to a call other than one of the first telephone call and the second telephone call selected for the voice interaction with the NLE. The call buffer may be for one of the first telephone call and the second telephone call not selected for the voice interaction. Moving forward, the option generation engine 216 may be configured to connect a microphone buffer and a speaker buffer to one or more call buffers associated with the one of the first telephone call and the second telephone selected for the voice interaction.

To that understanding, the activation engine 218 may be configured to active an NLE incorporated in the system 202. In an embodiment, the NLE may be present within the activation engine 218. The NLE may be configured to process one of the first telephone call and the second telephone call not selected for the voice interaction. The processing may be performed in a predefined conversion mode while one of the first telephone call and the second telephone call selected for the voice interaction is active via the voice interaction as the audio call. Moving forward, for processing one of the first telephone call and the second telephone call in the predefined conversion mode, the NLE may be configured to receive a first text and an incoming audio associated with one of the first telephone call and the second telephone call being processed by the NLE. The first text may be generated by a user of the electronic device. Furthermore, the incoming audio may be associated with another user of one of the first telephone call and the second telephone call being processed by the NLE. To that understanding, the NLE may be configured to convert the first text into a speech and the incoming audio into a second text.

FIG. 2B illustrates a schematic block diagram of an electronic device 200 for facilitating a plurality of telephone calls, in accordance with an embodiment of the disclosure. In an embodiment of the disclosure, the electronic device may be a single radio multi-SIM device. Examples of the electronic device may include, but are not limited to, a smartphone, a laptop, a PC, and a tablet. The embodiment of the electronic device 200 shown in FIG. 2B is for illustration only. Other embodiments of the electronic device 200 could be used without departing from the scope of this disclosure.

In an embodiment of the disclosure, the electronic device 200 may include at least one processor 204, and a memory 206. The processor 204, and the memory 206 may be communicatively coupled to one another.

In an embodiment of the disclosure, the electronic device 200 may exclude at least one of these components or may add at least one other component.

According to an embodiment of the disclosure, the processor 204 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

In an example, the processor 204 may be a single processing unit or a number of units, all of which could include multiple computing units. The processor 204 may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 204 may be configured to fetch and/or execute computer-readable instructions and/or data stored in the memory 206.

In an embodiment of the disclosure, the processor 204 may detect an initiation of a first telephone call among the plurality of telephone calls associated with a first Subscriber Identity Module (SIM) in the electronic device, wherein the initiation of the first telephone call is via one of a first SIM network associated with the first SIM or a second SIM network associated with a second SIM. The processor 204 may detect an initiation of a second telephone call among the plurality of telephone calls associated with a second SIM, wherein the initiation of the second telephone call is via one of the first SIM network or the second SIM network. And the processor 204 may activate a Natural Language Engine (NLE) for processing one of the first telephone call or the second telephone call in a predefined conversion mode, while another one of the first telephone call and the second telephone call is active via a voice interaction.

In an example, the memory 206 may include any non-transitory computer-readable medium known in the art including, for example, volatile memory, such as static random-access memory (SRAM) and/or dynamic random-access memory (DRAM), and/or non-volatile memory, such as read-only memory (ROM), erasable programmable ROM (EPROM), flash memory, hard disks, optical disks, and/or magnetic tapes.

In an embodiment of the disclosure, the memory 206 may store the text received from a user of the electronic device and incoming audio received from another user of one of the first telephone call or the second telephone call being processed by the NLE

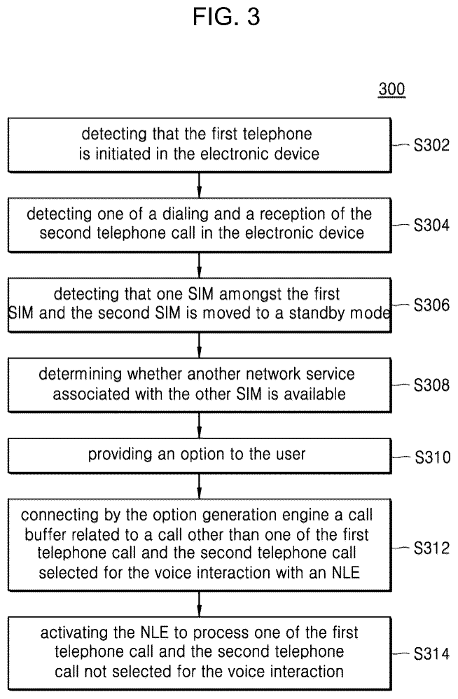

FIG. 3 illustrates an operational flow diagram depicting a process 300 for facilitating a plurality of telephone calls, in accordance with an embodiment of the disclosure. In an embodiment, the process 300 may be implemented by the system 202 as referred in FIG. 2A. In an embodiment, the system 202 may be incorporated in an electronic device such as a single radio multi-SIM device. The facilitation of the number of telephone calls may be performed simultaneously such that a user is capable to initiate or receive two telephone calls at a time. The number of telephone calls may include a first telephone call and a second telephone call. The first telephone call and the second telephone call may be one of an audio call between two users, and an audio conference call between at least three users.

At step S302, the process 300 may include detecting that the first telephone is initiated in the electronic device. The detection may be performed by the detection engine 214 as referred in FIG. 2A. The first telephone call may be for a first SIM and initiated via one of a first SIM network related to the first SIM, and a second SIM network related to a second SIM. Initiating the first telephone call may indicate that the first telephone call is active, and the first telephone call may be initiated from the electronic device or received at the electronic device.

At step S304, the process 300 may include detecting one of a dialing and a reception of the second telephone call in the electronic device. The detection may be performed by the detection engine 214. Further, the second call may be for the second SIM and the may be initiated from the electronic device or received at the electronic device via one of the first SIM network and the second SIM network. The first telephone call and the second telephone call may be simultaneously active. Furthermore, the Second telephone call may be initiated via one of the first SIM network related to the second SIM, and the second SIM network related to the second SIM.

At step S306, the process 300 may include detecting by the detection engine 214 that one SIM among the first SIM and the second SIM is moved to a standby mode. The detection may be performed in response to initiation of the first telephone call via the other SIM among the first SIM and the second SIM. The one SIM may be associated with a network service and the network service for the one SIM may be unavailable.

At step S308, the process 300 may include determining whether another network service associated with the other SIM is available. The determination may be performed by the detection engine 214. In an embodiment, where it is determined that the other network service associated with the other SIM is available, the process 300 may include registering the one SIM in the standby mode on the other network service associated with the other SIM for activating the one SIM on an evolved Packet Data Gateway (ePDG) of the other SIM.

At step S310, the process 300 simultaneous to step S304 and S306, may include providing an option to the user by the option generation engine 216 as referred in FIG. 2A. The option may be provided to the user in response to detection of the first telephone call and the second telephone call being simultaneously active. The option may be for selecting one of the first telephone call and the second telephone call for the voice interaction. Further, the process 300 may include receiving an input signal from the user indicating which one of the first telephone call and the second telephone call is selected for activation via the voice interaction. The voice interaction may indicate that one of the first telephone call and the second telephone call selected for the voice interaction is to be continued as an audio call.

At step S312, the process 300 may include connecting by the option generation engine 216 a call buffer related to a call other than one of the first telephone call and the second telephone call selected for the voice interaction with an NLE. The call buffer may be for one of the first telephone call and the second telephone call not selected for the voice interaction. Further, the process 300 may include connecting by the option generation engine 216 a microphone buffer and a speaker buffer to one or more call buffers associated with the one of the first telephone call and the second telephone selected for the voice interaction.

At step S314, the process 300 may include activating by the activation engine 218 the NLE to process one of the first telephone call or the second telephone call not selected for the voice interaction. The processing may be performed in a predefined conversion mode while one of the first telephone call and the second telephone call selected for the voice interaction is active via the voice interaction as the audio call. Moving forward, for processing one of the first telephone call and the second telephone call in the predefined conversion mode, the NLE may be configured to receive a first text and an incoming audio associated with one of the first telephone call and the second telephone call being processed by the NLE. The first text may be generated by a user of the electronic device.

Furthermore, the incoming audio may be associated with another user of one of the first telephone call and the second telephone call being processed by the NLE. To that understanding, the NLE may be configured to convert the first text into a speech and the incoming audio into a second text.

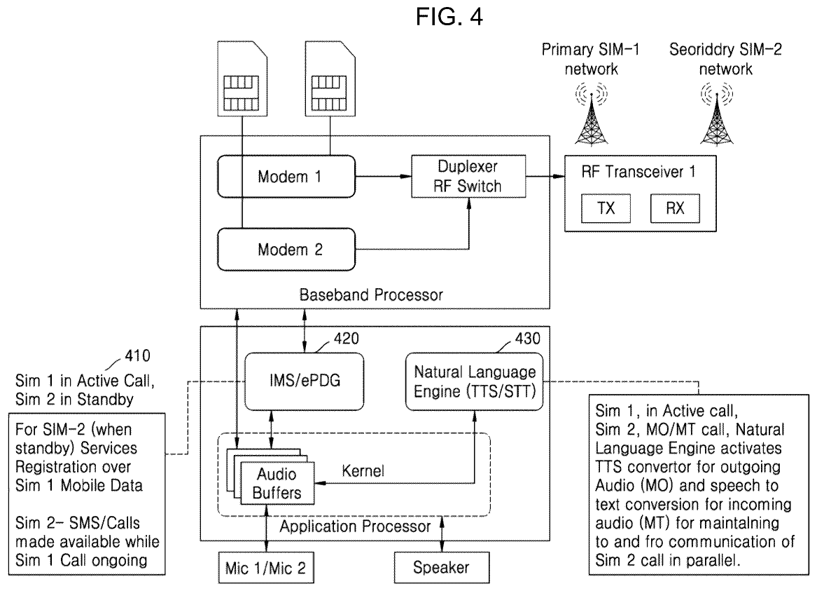

FIG. 4 illustrates an architectural flow diagram 400 of an electronic device configured to facilitate a plurality of telephone calls, in accordance with an embodiment of the disclosure. The number of telephone calls may include a fist telephone call and a second telephone call. Furthermore, the electronic device may include a first SIM associated with a first network and a second SIM associated with a second network.

The detection engine 214 may be configured to detect that the first telephone is initiated in the electronic device. The first telephone call may be for a first SIM. Furthermore, the first telephone call may be initiated via one of a first SIM network related to the first SIM, and a second SIM network related to a second SIM. Initiating the first telephone call may indicate that the first telephone call is active, and the first telephone call may be initiated from the electronic device or received at the electronic device. In an embodiment, the first telephone call may be active via the first SIM and the second SIM may be on a standby mode (410). When the second SIM is on the standby mode, a network service associated with the second SIM may be unavailable. In an embodiment, where it is determined that a network service associated with the first SIM is available, the second SIM may be registered over the network service of the first SIM for activating the second SIM on an evolved Packet Data Gateway (ePDG) (420) of the first SIM.

Further, when the second telephone call is dialed or received at the electronic device while the first telephone call is active, a Natural Language Engine (NLE) (430) may be configured to activate a Text To Speech (TTS) convertor for outgoing Audio (MO) and a Speech To Text (STT) convertor for incoming audio (MT) for maintaining a to and from communication of the second telephone call one the second SIM in parallel to the first telephone call on the first SIM such that the number of telephone calls may be facilitated. Further, a call buffer may be selected for the second telephone call and a microphone buffer and a speaker buffer may be connected to one or more call buffers associated with the first telephone call for the voice interaction. In the above embodiment, the first telephone call may be continued in the form of an audio call whereas the second telephone call may be continued by the NLE (430) to facilitate the number of telephone calls active at a similar time in the electronic device.

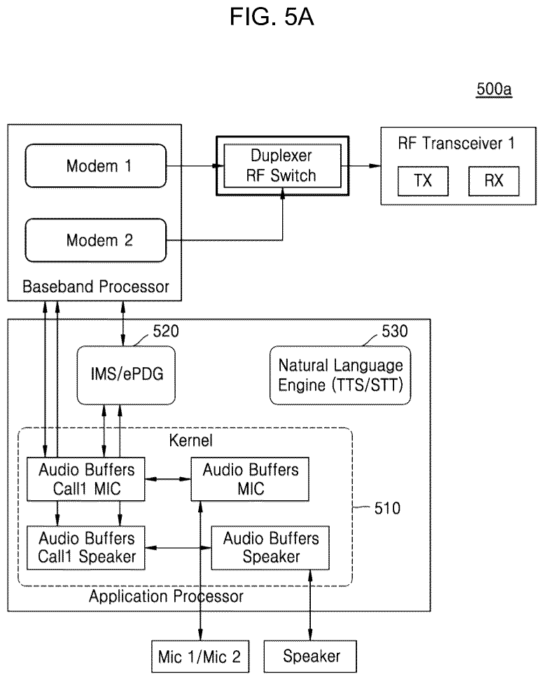

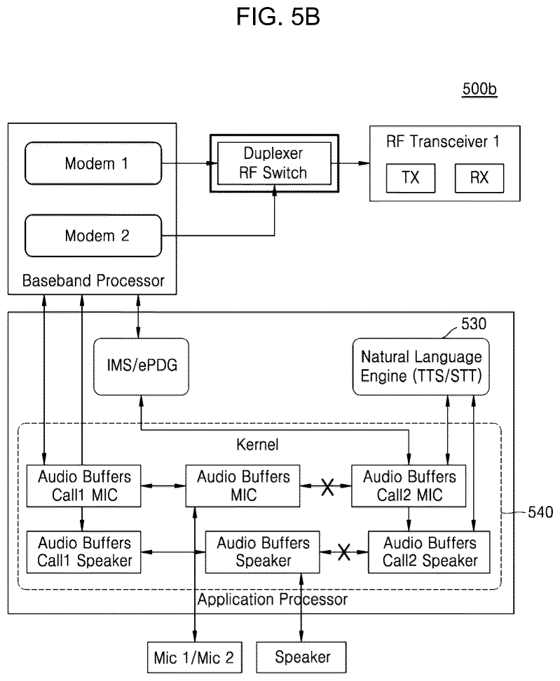

FIG. 5A illustrates an operational flow diagram depicting a process 500a for preparing a number of resources required for a first telephone call, in accordance with an embodiment of the disclosure. The number of resources may include a microphone buffer and a speaker hardware buffer (510). The first telephone call may be one of an audio call between two users, and an audio conference call between at least three users. The first telephone call may be associated with one of a first SIM and a second SIM.

In an embodiment, the process 500a may include detecting whether one of the first SIM and the second SIM is registered over ePDG (520) and allowing a call concurrency for the first telephone call and the second telephone call with a multimedia framework. In an embodiment, where the first telephone call is initiated via one of the first SIM and the second SIM, the speaker and the microphone hardware buffer may be allocated by passing sound through one or more jumpers using additional audio buffers. Further, in an embodiment, the first telephone call may be on a network service of one of the first SIM and the second SIM associated with the network service. In another embodiment, the first telephone call may be over the ePDG using a network service of another SIM from the first SIM and the second SIM.

Furthermore, in an embodiment, where the first telephone call is over the network service of one of the first SIM and the second SIM associated with the network service, a configuration may be passed to a Control Plane (CP). In another embodiment, where the first telephone call is over ePDG using the network service of another SIM from the first SIM and the second SIM, the configuration may be passed to an ePDG voice engine.

FIG. 5B illustrates an operational flow diagram depicting a process 500b for preparing a number of resources for a second telephone call while the first telephone call is active, in accordance with an embodiment of the disclosure. The first call and the second telephone call may be facilitated in an electronic device while being active at a same time. Facilitating the number of telephone calls may include continuing one call among the first telephone call and the second telephone call via a voice interaction in the form of the audio call at the same time along with another call from the first telephone call and the second telephone call an NLE (530). The NLE (530) may be among the number of resources along with call buffers (540) connected to a microphone and a speaker.

In an embodiment, the process 500b may include providing an option to the user by the option generation engine 216 as referred in FIG. 2A. The option may be for selecting one of the first telephone call and the second telephone call for the voice interaction. Further, a command may be received from the user indicating that one of the first telephone call and the second telephone call is selected for the voice interaction. The voice interaction may indicate that one of the first telephone call and the second telephone call selected for the voice interaction is to be continued as the audio call.

To that understanding, for one of the first telephone call and the second telephone call selected for the voice interaction, a microphone buffer and a speaker buffer may be connected to a call buffer and other call buffers may be connected to a Natural Language Processing (NLP) engine. If the user needs to switch between the first telephone call and the second telephone call then buffers of the first call may be connected with the NLP engine and buffers of the second telephone call may be connected to the microphone and the speaker.

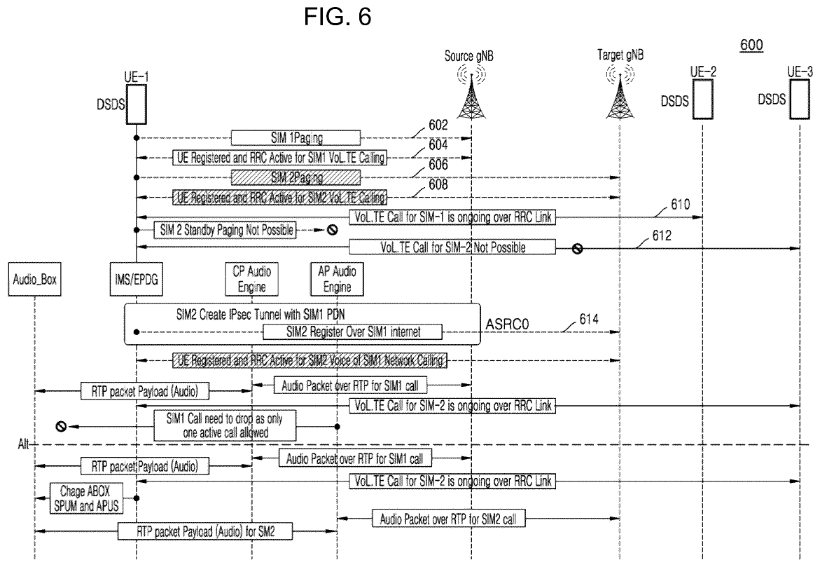

FIG. 6 illustrates an operational flow diagram depicting a process 600 for processing one telephone call among a first telephone call and a second telephone call in a predefined conversion mode, in accordance with an embodiment of the disclosure. The first telephone call and the second telephone call may be pursued simultaneously on an electronic device. The one telephone call may be selected by a user to not be pursued as an audio call and the one call may be pursued in the predefined conversion mode. In the predefined conversion mode, a TTS and a STT conversion may take place such that, a text from the user is converted to a speech and a speech from a person on the one telephone call is converted to the text. The user may simultaneously be on another telephone call being continued as the audio call among the first telephone call and the second telephone call.

At step S602, the process 600 may include performing paging for a first SIM by the electronic device on a network.

At step S604, the process 600 may include registering the first SIM of the electronic device at the network for Voice over Long Term Evolution (VoLTE) calling.

At step S606, the process 600 may include performing paging for a second SIM by the electronic device on the network.

At step S608, the process 600 may include registering the second SIM of the electronic device at the network for VOLTE calling.

At step S610, the process 600 may include initiating the first telephone call via the first SIM over an RRC link.

At step S612, the process 600 may include detecting that the second SIM is on standby mode and the electronic device may be unable to initiate the second telephone call upon initiation of the first telephone call via the first SIM.

At step S614, the process 600 may include registering the second SIM on network service of the first SIM.

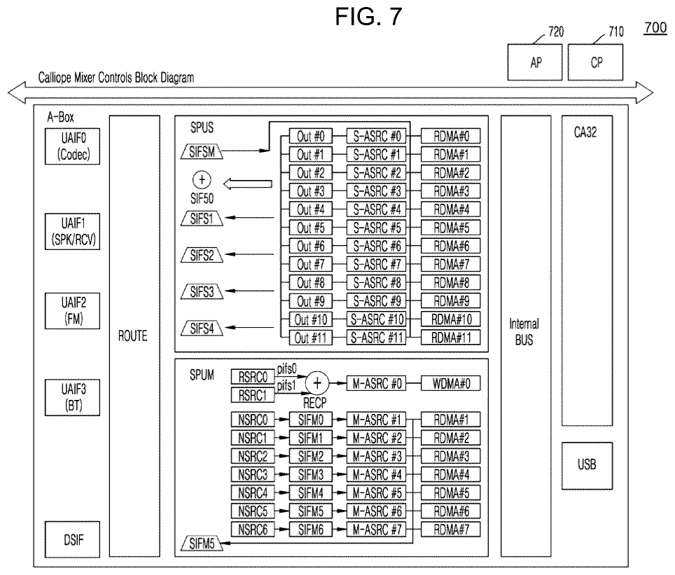

The detail description of function of the audio box after step S614 is described in FIG. 7.

FIG. 7 illustrates a diagram 700 depicting an audio box for continuing one of a first telephone call and a second telephone call, in accordance with an embodiment of the disclosure. The audio box may be incorporated with an electronic device configured to initiate the first telephone call and the second telephone call. The first telephone call may be associated with a first SIM and the second telephone call may be associated with a second SIM in the electronic device. The audio box may include a CP audio engine (710) and an AP audio engine (720). The CP audio engine (710) may be configured to provide audio for the first telephone call via a microphone and a speaker. The AP audio engine (720) may be configured to pursue the second call in a predefined conversion mode. In the predefined conversion mode, a TTS and a STT conversion may take place such that, a text from the user is converted to a speech and a speech from a person on the one telephone call is converted to the text.

While specific language has been used to describe the present disclosure, any limitations arising on account thereto, are not intended. As would be apparent to a person in the art, various working modifications may be made to the method in order to implement the inventive concepts as taught herein. The drawings and the foregoing description give examples of embodiments. Those skilled in the art will appreciate that the described elements may well be combined into a single functional element. Alternatively, certain elements may be split into multiple functional elements. Elements from one embodiment may be added to another embodiment. Clearly, the present disclosure may be otherwise variously embodied, and practiced within the scope of the following claims.

According to an aspect of the disclosure, a method implemented in an electronic device for facilitating a plurality of telephone calls, is disclosed. The method includes detecting that an initiation of a first telephone call among the plurality of telephone calls associated with a first Subscriber Identity Module (SIM) in the electronic device. The first telephone call is initiated via one of a first SIM network associated with the first SIM or a second SIM network associated with a second SIM. The method includes detecting an initiation of a second telephone call among the plurality of telephone calls associated with a second SIM. The initiation of the second telephone call is via one of the first SIM network and the second SIM network. The method further includes activating a Natural Language Engine (NLE) for processing one of the first telephone call or the second telephone call in a predefined conversion mode. Another one of the first telephone call and the second telephone call is active via a voice interaction.

In an embodiment of the disclosure, the method further comprises detecting that one SIM among the first SIM and the second SIM is moved to a standby mode in response to initiation of the first telephone call via the other SIM among the first SIM and the second SIM, wherein a network service associated with the one SIM is unavailable. The method further comprises determining whether the other network service associated with the other SIM is available and registering the one SIM in the standby mode on the other network service associated with the other SIM in response to the determination for activating the one SIM on an evolved Packet Data Gateway (ePDG) of the other SIM.

In an embodiment of the disclosure, the method further comprises receiving an input signal indicating which of the first telephone call and the second telephone call is selected for activation via the voice interaction and connecting a call buffer associated with a call other than one of the first telephone call and the second telephone call selected for the voice interaction with the NLE.

In an embodiment of the disclosure, the method further comprises connecting a microphone buffer and a speaker buffer to one or more call buffers associated with the one of the first telephone call and the second telephone selected for activation via the voice interaction.

In an embodiment of the disclosure, the electronic device is a single radio multi-SIM device.

In an embodiment of the disclosure, the method further comprises receiving a first text and an incoming audio associated with one of the first telephone call or the second telephone call being processed by the NLE, wherein the first text is received by a user of the electronic device and the incoming audio is received by another user of one of the first telephone call or the second telephone call being processed by the NLE. The method further comprises converting the first text into a speech and the incoming audio into a second text.

In an embodiment of the disclosure, the first telephone call and the second telephone call occurs based on at least one of the first SIM network associated with the first SIM, the first SIM network associated with the second SIM, the second SIM network associated with the second SIM, or the second SIM network associated with the first SIM.

According to an aspect of the disclosure, an electronic device for facilitating a plurality of telephone calls, is disclosed. The electronic device comprises at least one memory and at least one processor coupled with the at least one memory. The at least one processor is configured to detect that an initiation of a first telephone call among the plurality of telephone calls associated with a first Subscriber Identity Module (SIM) in the electronic device. The first telephone call is initiated via one of a first SIM network associated with the first SIM or a second SIM network associated with a second SIM. The at least one processor is further configured to detect an initiation a second telephone call among the plurality of telephone calls associated with a second SIM. The initiation of the second telephone call is via one of the first SIM network or the second SIM network. The at least one processor is further configured to activate an NLE for processing one of the first telephone call or the second telephone call in a predefined conversion mode. Another one of the first telephone call and the second telephone call is active via a voice interaction.

According to an aspect of the disclosure, a machine-readable medium that stores instructions to be executed by at least one processor to perform methods described in the disclosure, is described.

Embodiments of the method and device described herein improve the functioning of a computer by enabling multiple phone calls on a single device. These problems of enabling multiple phone calls on a single device are present in the realm of computation and networks. Thus, embodiments herein are rooted in computer technology to overcome a problem arising in the realm of computer networks.

What is claimed is:

1. A method performed by an electronic device for facilitating a plurality of telephone calls, the method comprising:
detecting an initiation of a first telephone call associated with a first Subscriber Identity Module (SIM) of the electronic device, wherein the initiation of the first telephone call is via one of a first SIM network or a second SIM network;
detecting an initiation of a second telephone call associated with a second SIM of the electronic device, wherein the initiation of the second telephone call is via one of the first SIM network or the second SIM network; and
activating a Natural Language Engine (NLE) for processing one of the first telephone call or the second telephone call as an NLE call, while another of the first telephone call or the second telephone call is active via a voice interaction as a voice call.

2. The method of claim 1, further comprising:
detecting that one SIM among the first SIM and the second SIM is moved to a standby mode in response to initiation of the first telephone call via another SIM among the first SIM and the second SIM, wherein a network service associated with the one SIM is unavailable;
determining whether another network service associated with the other SIM is available; and
registering the one SIM in the standby mode on the other network service based on the determining, to activate the one SIM on an evolved Packet Data Gateway (ePDG) of the other SIM.

3. The method of claim 1, wherein the activating the NLE comprises:
receiving an input signal indicating which of the first telephone call and the second telephone call is selected as the voice call; and
connecting a call buffer for the voice call.

4. The method of claim 3, further comprising:
connecting a microphone buffer and a speaker buffer to the call buffer.

5. The method of claim 1, wherein the electronic device is a single radio multi-SIM device.

6. The method of claim 1, wherein the activating the NLE comprises:
receiving a first text and an incoming audio associated with the NLE call, wherein the first text is received by a user of the electronic device and the incoming audio is received by another user of the NLE call; and
converting the first text into a speech and the incoming audio into a second text.

7. The method of claim 1, wherein the first telephone call and the second telephone call occur based on at least one of:
the first SIM network connected with the first SIM;
the first SIM network connected with the second SIM;
the second SIM network connected with the second SIM; or
the second SIM network connected with the first SIM.

8. An electronic device for facilitating a plurality of telephone calls, the electronic device comprising:
at least one processor; and
at least one memory storing instructions,
wherein the instructions, when executed by the at least one processor individually or collectively, cause the device to:
detect an initiation of a first telephone call associated with a first Subscriber Identity Module (SIM) of the electronic device, wherein the initiation of the first telephone call is via one of a first SIM network or a second SIM network;
detect an initiation of a second telephone call associated with a second SIM of the electronic device, wherein the initiation of the second telephone call is via one of the first SIM network or the second SIM network; and
activate a Natural Language Engine (NLE) for processing one of the first telephone call or the second telephone call as an NLE call, while another of the first telephone call and the second telephone call is active via a voice interaction as a voice call.

9. The electronic device of claim 8, wherein the instructions, when executed by the at least one processor individually or collectively, cause the device to:
detect that one SIM among the first SIM and the second SIM is moved to a standby mode based on the initiation of the first telephone call via another SIM among the first SIM and the second SIM, wherein a network service associated with the one SIM is unavailable;
determine whether another network service associated with the other SIM is available; and
register the one SIM in the standby mode on the other network service based on the determining, to activate the one SIM on an evolved Packet Data Gateway (ePDG) of the other SIM.

10. The electronic device of claim 8, wherein the instructions, when executed by the at least one processor individually or collectively, cause the device to:
receive an input signal indicating which of the first telephone call and the second telephone call is selected as the voice call; and
connect a call buffer for the voice call.

11. The electronic device of claim 10, wherein the instructions, when executed by the at least one processor individually or collectively, cause the device to:
connect a microphone buffer and a speaker buffer to the call buffer.

12. The electronic device of claim 8, wherein the electronic device is a single radio multi-SIM device.

13. The electronic device of claim 8, wherein the instructions, when executed by the at least one processor individually or collectively, cause the device to:
receive a first text and an incoming audio associated with the NLE call, wherein the first text is received by a user of the electronic device and the incoming audio is received by another user of the NLE call; and
convert the first text into a speech and the incoming audio into a second text.

14. The electronic device of claim 8, wherein the first telephone call and the second telephone call occurs based on at least one of:
the first SIM network connected with the first SIM;
the first SIM network connected with the second SIM;
the second SIM network connected with the second SIM; or
the second SIM network connected with the first SIM.

15. A non-transitory computer-readable medium that stores instructions executed by at least one processor of an electronic device to cause the electronic device perform a method for facilitating a plurality of telephone calls, the method comprising:
detecting an initiation of a first telephone call associated with a first Subscriber Identity Module (SIM) of the electronic device, wherein the initiation of the first telephone call is via one of a first SIM network or a second SIM network;
detecting an initiation of a second telephone call associated with a second SIM of the electronic device, wherein the initiation of the second telephone call is via one of the first SIM network or the second SIM network; and
activating a Natural Language Engine (NLE) for processing one of the first telephone call or the second telephone call as an NLE call, while another of the first telephone call or the second telephone call is active via a voice interaction as a voice call.

16. The non-transitory computer-readable medium of claim 15, wherein the method further comprises:
detecting that one SIM among the first SIM and the second SIM is moved to a standby mode in response to initiation of the first telephone call via another SIM among the first SIM and the second SIM, wherein a network service associated with the one SIM is unavailable;
determining whether another network service associated with the other SIM is available; and
registering the one SIM in the standby mode on the other network service based on the determining, to activate the one SIM on an evolved Packet Data Gateway (ePDG) of the other SIM.

17. The non-transitory computer-readable medium of claim 15, wherein the activating the NLE comprises:
receiving an input signal indicating which of the first telephone call and the second telephone call is selected as the voice call; and
connecting a call buffer for the voice call.

18. The non-transitory computer-readable medium of claim 17, wherein the method further comprises:
connecting a microphone buffer and a speaker buffer to the call buffer.

19. The non-transitory computer-readable medium of claim 15, wherein the electronic device is a single radio multi-SIM device.

20. The non-transitory computer-readable medium of claim 15, wherein the activating the NLE comprises:
receiving a first text and an incoming audio associated with the NLE call, wherein the first text is received by a user of the electronic device and the incoming audio is received by another user of the NLE call; and
converting the first text into a speech and the incoming audio into a second text.
